(19) United States
(12) Patent Application Publication
(10) Pub. No.: US 2005/0198845 A1
(43) Pub. Date: Sep. 15, 2005

(54) Multiple laser laser level

(76) Inventor: Glenn Robinson, Parkland, FL (US)

Correspondence Address: COOPER & DUNHAM, LLP, 1185 AVENUE OF THE AMERICAS, NEW YORK, NY, 10036, US

(21) Appl. No.: 11/062,023

(22) Filed: Feb. 18, 2005

Related U.S. Application Data
(60) Provisional application No. 60/546,275, filed on Feb. 19, 2004.

(51) Int. Cl. G01C 1/00

(52) U.S. Cl. 33/227

(57) ABSTRACT

A laser level which projects one to four laser lines on surfaces capable of reflecting light within a projection envelope around the laser level such that the lines can provide plumb, level, and/or other guide lines on any surface facing the laser level within the projection envelope of the laser level.

### CROSS-REFERENCES TO RELATED APPLICATIONS

This application claims the benefit of U.S. Provisional Application Ser. No. 60/546,275 filed Feb. 19, 2004.

### BACKGROUND OF THE INVENTION

This invention relates to a device for projecting one or more lines of light generated by a laser or lasers on surfaces such as a walls and/or for using such lines as guides, for example, as level and plumb lines.

Levels utilizing a battery powered laser that project a light beam on surfaces to help homemakers and professionals locate a guideline are known in the art, see for example, U.S. Patent Publication No. 2002/0166249. Such devices are typically mounted on a tripod in the center of a room, are positioned to be level, and project horizontal and/or vertical light beams onto a wall, see for example, U.S. Pat. No. 5,864,956.

### BRIEF SUMMARY OF THE INVENTION

It is an object of the invention is to provide a laser level which can be easily adjusted to independently project two or more guidelines at any of a range of distances from the laser source.

Another object of the invention is to provide a laser level which can be easily adjusted to independently project two or more guidelines at any of several orientations including a horizontal and vertical position.

A further object of the invention is to provide a battery powered laser level that projects a bright red beam on surfaces to help the homemaker, as well as the professional, in the task of locating and leveling pictures, photographs, posters, wall moldings, millwork, laying wall and floor tile and any other task which require plumb lines, level lines, angled lines, straight lines and/or other projected guide lines.

An additional object of the invention is to provide a laser level which can be attached to all types of surfaces, including but not limited to dry wall, wood, plaster surfaces, vinyl, plastic, steel, tile and any non-porous surface.

Another object of the invention is to provide a device for providing guidelines having: (1) a housing; (2) at least two pods attached to the housing and moveable with respect to the housing, each pod having a light source for projecting a guideline of light through a respective point on a respective surface; (3) a first adjustor for each pod to locate the respective point on the respective surface; and (4) a second adjustor for each pod to rotate the respective guideline through the respective point. Further, at least two of the pods can be positioned to project the respective points at a right angle with respect to each other. Also, the housing can have: (a) a level which indicates the true level of the housing; (b) a switch to activate any combination of the light sources; and/or (c) a source of power, which can be batteries provided inside the housing and/or a receptacle to receive power from elsewhere in the device or an external supply.

In addition, the first adjustor of the device can have an attitude control for moving the pod with respect to the housing; and/or the second adjustor can have: (a) a lens for converting a beam of light from the light source into a guideline; (b) a frame for supporting the lens; and (c) a rotation control for rotating the frame.

Another object of the invention is to provide a rotatable base for the device having: (a) a first section which attaches to the housing; (b) a second section for placement on a surface; and (c) a rotation mechanism to allow the first section to rotate with respect to the second section. Also, the base can have stops at certain angles of the rotation of the first section with respect to the second section. Further, the rotatable base can have one or more pin units, each pin unit having: (a) one or more pins for connection to the surface on which the base is placed; and (b) an actuator for moving the pins from a retracted position inside the second section to an extended position such that the pins can penetrate the surface. Also, the device can have a suction cup unit having: (a) one or more suction cups for connection to the surface; and/or (b) a suction cup connector for connecting the suction cup to the base.

Additionally, the rotatable base can have: (a) an attachment device for releasable attaching the housing to the first section, which can be one or more magnets; (b) a level which indicates the true level of the base; and (c) a measuring device which, in one embodiment can measure distance.

A further object of the invention is to provide a method of using the device having the steps of: (1) placing the housing on a first surface; (2) adjusting each pod with each respective first adjustor to locate a respective point on a respective target surface; and (3) adjusting each pod with each respective second adjustor to rotate the respective guideline to a desired position. In addition, the method can also include the steps of: (a) attaching the housing to a base, the base having a first section rotatably connected to a second section; and/or (b) rotating the first section with respect to the second section to position the pods. Further, the placing step can include the steps of: (a) engaging an activator in the base to move pins from a retracted position inside the second section to an extended position so that the pins can penetrate the first surface; (b) attaching a convex side of a suction cup to the base and a concave side of the suction cup to the first surface; and/or (c) attaching a tripod base to a tripod, adjusting the tripod base to be at true level, and attaching the laser level to the tripod base.

### BRIEF DESCRIPTION OF THE SEVERAL VIEWS OF THE DRAWINGS

FIG. 1 illustrates a perspective view of a laser level near two walls according to one embodiment of the invention;

FIG. 2 illustrates a partial sectional perspective view of a laser level according to one embodiment of the invention;

FIG. 3 illustrates a top view of a laser level according to one embodiment of the invention;

FIG. 4 illustrates a partial sectional side view of a laser level according to one embodiment of the invention;

FIG. 5 illustrates a side view of a laser level including a base according to one embodiment of the invention; and

FIG. 6 illustrates a bottom view of a laser level according to one embodiment of the invention.

### DETAILED DESCRIPTION OF THE INVENTION

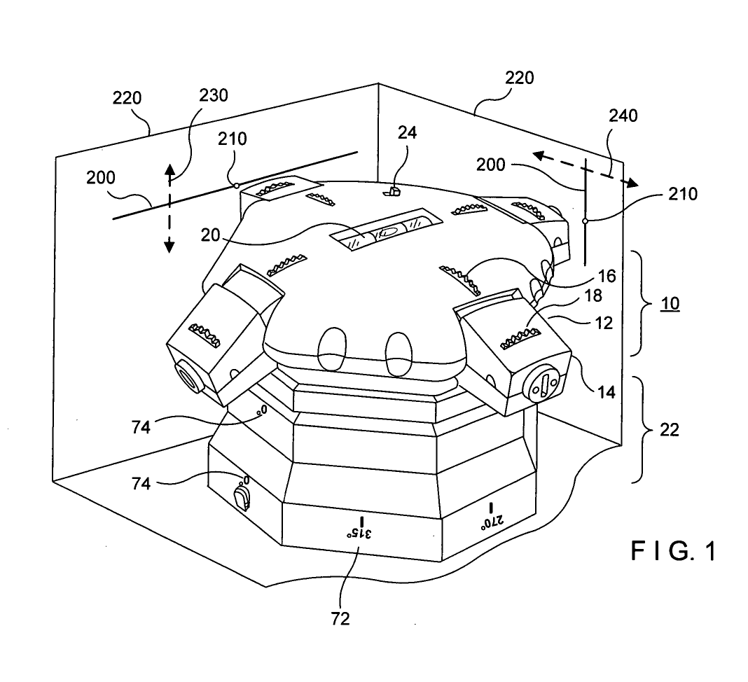

A laser level 10 according to one embodiment of this invention is illustrated in FIG. 1. Laser level 10 includes a housing 12, four independent, fully adjustable laser pods 14, four pod attitude controls 16, four pod rotation controls 18, a liquid bubble level 20 and a switch 24. In one embodiment, each of the pod controls 16, 18 are thumb wheels. The housing 12 can also include finger grips 26 for manipulating the laser level 10. Also shown in FIG. 1 is stand 22 on which the laser level 10 can be removably mounted.

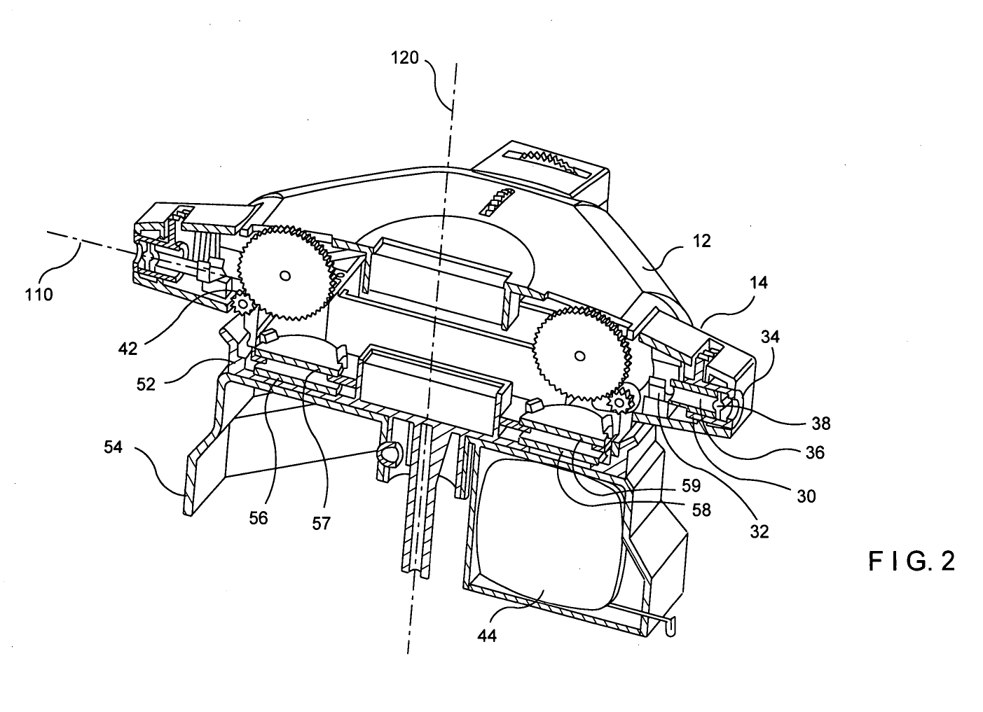

As shown in FIG. 2, each pod 14 is adjustably mounted to the housing 12. Each pod includes a battery powered laser module 30 with the associated electronics 32. Each laser module 30 includes a rotatable frame 34 to which a laser source 36 and a lens 38 are mounted. Each laser source 36 and lens 38 is configured to project respective guidelines 200 through respective points 210 onto one or more surfaces 220 upon which the projected guidelines 200 impinge.

In one embodiment, each laser source 36 projects a beam of light along the pod central axis 110 and through a respective lens 38. Each lens 38 has a cylindrical shape with its symmetric axis positioned perpendicular to the beam of light emitted from the laser source 36. Accordingly, each lens 38 disperses the light in a wide angle to appear as a guidelines 200 on surfaces 220.

Because each rotatable frame 34 permits +/−180 degrees of rotation of the respective laser module 30 around the central pod axis 110, by turning the rotatable frame 34 using the corresponding pod rotation control 18, the respective guideline 200 can be directed in any direction, that is at any angle, through the point 210 on the surface 220.

Furthermore, because each pod 14 can be angled up or down up to +/−180 degrees with respect to the central body axis 120 by using the corresponding pod attitude control 16, which in one embodiment is connected to the pod by a gear 42, the location of the guideline 200 on the surface 220 can be moved along the surface in at least two directions 230.

Moreover, because each pod 14 is mounted to the housing 12, rotation of the housing about the central body axis 120, will move the location of the points 210 on the surfaces 220 in a second direction 240 which is orthogonal to the first direction 230. Thus, according to one embodiment of this invention, by adjusting the pod attitude controls 16, the pod rotation controls 18, and the housing 12, each pod 14 can project a guideline 200 in any direction through any point on any surface 220 reachable by the light from the laser module 30 In other words, the laser level 10 projects one to four laser lines 200 on surfaces 220 capable of reflecting light within a projection envelope around the laser level such that the lines 200 can provide plumb, level, and/or other guide lines 360 degrees around the central body axis 120 and in any plane within the projection envelope of the laser level.

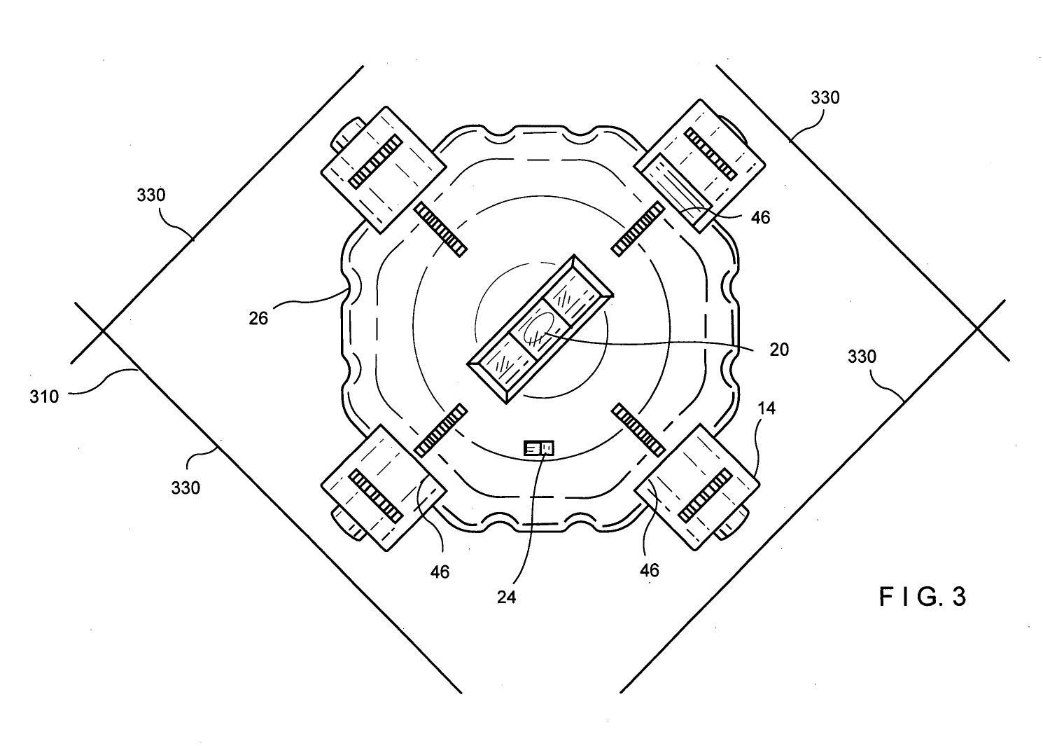

In one embodiment of the invention, one or more particular positions of the pod 14 and the housing 12 can be indicated to a user, for example, by marks on the pod controls 16, 18 and the housing 12 or by stops which limit the movement of the pod 14 or the pod controls 16, 18 to the particular positions. Particular positions of interest which have stops according to one embodiment of the invention include, but are not limited to, when the guideline 200 of a pod 14 is: (1) in the same plane as the central body axis 120; (2) in a plane perpendicular to the central body axis; and (3) in the central plane of the housing 12, that is, the plane defined by the pod central axes 110 when perpendicular to the central body axis 120. For example, FIG. 3 shows stop 46 for a pod 14. When the edge of pod 14 abuts the edge/stop 46 on the housing 12, a horizontal guideline 200 emitted from that pod is in the same plane as the central plane of the housing 12. Similarly, in one embodiment, the movement of the thumb wheels 16, 18 is stopped in one direction when a vertical guideline 200 is in the same plane as the central body axis 120 and is stopped in the other direction when a horizontal line is in a plane perpendicular to the central body axis 120. In one embodiment, one or more of the stops do not limit movement, but instead provide some resistance (“resistance stops”) to further movement indicating that a position of interest has been reached.

In one embodiment, the laser sources 36 are turned on by a single multiple position switch 24. The positions can be, for example, OFF, LASER 1 ON, LASERS 1 & 2 ON, LASERS 1, 2 & 3 ON, LASERS 1, 2, 3 & 4 ON. Alternatively, a two position switch can be provided which turns all the light sources on or off at the same time.

In one embodiment, to operate the laser level 10, the user can either hold the laser level or place the laser level on a surface. If guidelines 200 based on true level are desired, the user can use the bubble level 20 to properly position the laser level 10 at true level. The user can then rotate the laser level and use thumb wheels 16 to position each guideline 200 on the desired surface 220, and then rotate each guideline 200 to the respective desired direction using thumb wheels 18.

In one embodiment, a base or stand 22 can be used. The stand 22 includes an upper piece 52 that holds or receives the housing 12. The housing 12 can be held in one or more predetermined positions on the stand 22 using magnets 56, 58 with metal plates 57, 59 or any other attachment devices such as, for example, hook and loop fasteners. The stand 22 can also include a bubble indicator (not shown) for determining true level for the stand 22. In one embodiment, the upper piece 52 and lower piece 54 of the stand 22 are rotatably attached and can pivot with respect to each other. Further, in one embodiment, alignment marks 72, 74 are provided on each piece 52,54 so that a variety of angles can be accurately selected by rotating the two pieces with respect to each other. The rotation being possible for a full 360 degrees with “HOME” alignment marks 74 positioned at zero degrees, and angles of interest such as 45 degrees increments relative to the HOME alignment indicated by resistance stops as well.

In one embodiment, to operate the laser level 10 with the stand 22, the user can place the stand 22 on a surface and adjust the stand 22 to be at true level using bubble indicator on the stand. Then, the user can attach the laser level 10 to the upper piece 52 in one of the predetermined positions. Since the stand 22 was positioned at true level, the laser level 10 should be at true level as well. The user can then operate the laser level as discussed above.

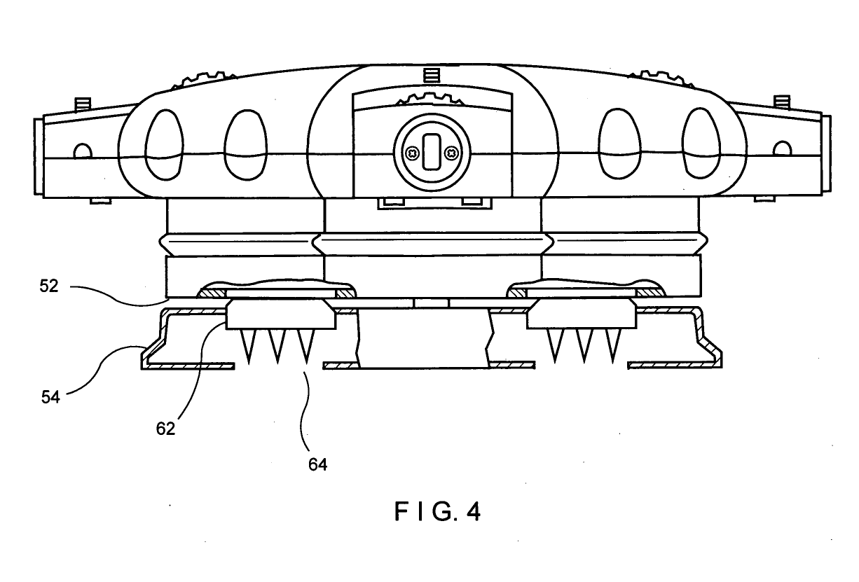

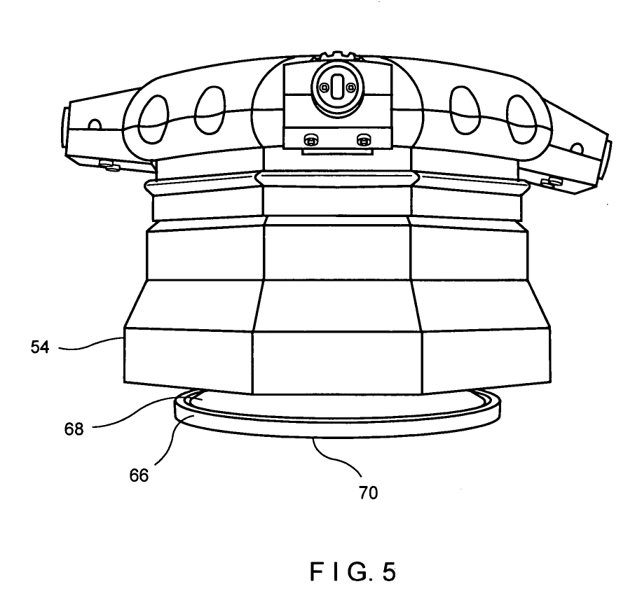

To hold the stand 22 on a surface 220, and particularly when the surface is vertical, such as for a wall, in one embodiment as shown in FIG. 4, the lower piece 54 contains two spring return push button pin units 62 that when depressed each project three pins 64 out of the bottom of the stand 22 for connection to porous or malleable rigid surfaces such as drywall or wood. Alternatively, as shown in FIG. 5, a suction cup unit 66 can be attached on its convex side 68 to the bottom of the lower piece 54, and the concave side 70 can be pressed against the surface to hold the stand 22 and the attach laser level 10 in place. The suction cup unit 66 is particularly useful on non-porous surfaces such as glass, tile, or steel.

Alternatively, the lower piece 54 can be removable so separate lower pieces can be provided for push button units 62, the suction cup unit 66, or a flat bottom.

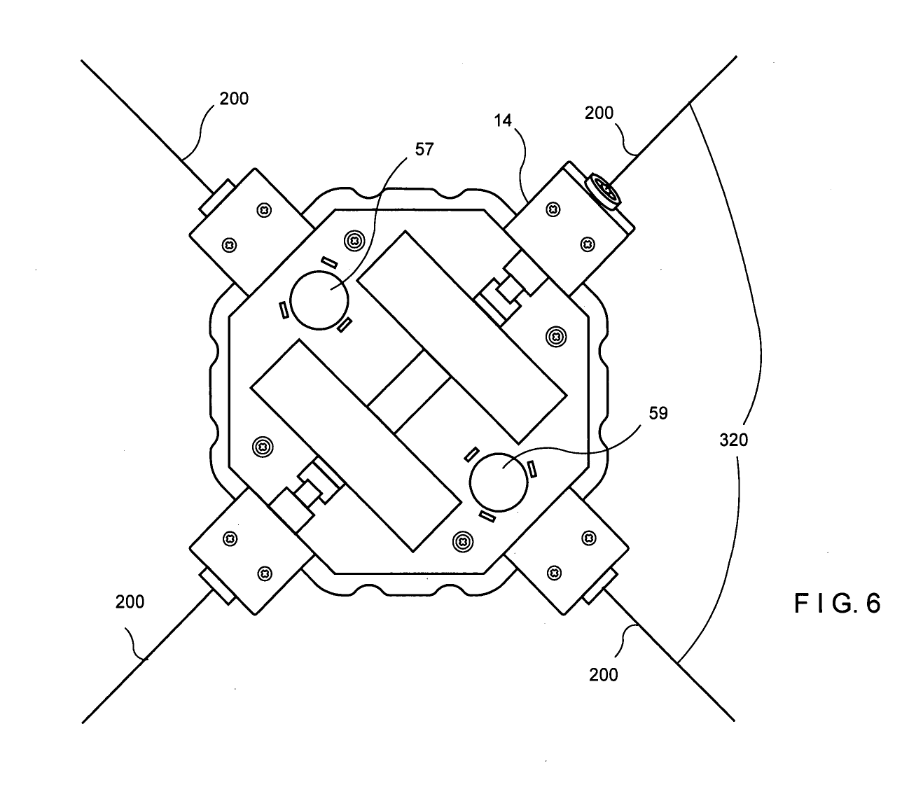

Two particularly useful configurations provided by the laser level 10 with or without the stand 22, are to project light on the same surface on which the laser level is standing and have the guidelines 200 form a rectangular shape 310, see FIG. 3, or a cross shape 320, see FIG. 6.

To achieve the rectangular configuration 310, the four guidelines 200 are adjusted with the pod rotation controls 16 to be in plane perpendicular to the central body axis 120. Then, the pod attitude controls 18 are adjusted to provide the edges 330 of a rectangle of a desired size. The attitude controls 18 will move each line along the direction 230 thereby moving the respective edge 330 and increasing or decreasing the length of the adjacent edge.

One use of the rectangular configuration 310 is to project a box on the surface 220 which because the size and angle of the box is adjustable, can be used to visualize what the object, such as a picture or window, might look like on a wall. This footprint can describe objects including, but not limited to: picture frames, tiles, window, doors, ceiling fans, light fixtures, pictures, posters, photographs, wall moldings, millwork, wall and floor tile or any object that can be described by height and width attributes.

To achieve the cross configuration 320, the four lines 200 are adjusted with the pod rotation controls 16 to be in same plane as the central body axis 120 which causes the guidelines 200 to be directed away from the center of the housing 12 at right angles with respect to each other.

In one embodiment, the laser level 10 includes a tape measure 44 mounted in the stand 22 which allows the user to measure the distance along, or to, a guideline 200 projected from the laser pod 14 positioned above the tape measure.

The laser level 10 also can be mounted to a tripod using a tripod mounting base (not shown) which includes an upper piece and a lower piece similar to the stand 22. The tripod, however, allows the user to easily adjust the height and orientation of the projection envelope by raising, lowering, or tilting the mounting base to which the laser level 10 is attached. The orientation of the projection envelope (and the laser level itself) can be perpendicular to the central axis of the tripod's main arm, or parallel to the center axis of the tripod's main arm and every angle in between. These orientations allow the user to create a projection envelope on either all contiguous and noncontiguous vertical surfaces or on all contiguous and noncontiguous horizontal surfaces and on all the surface angles in between.

In one embodiment, the tripod mounting base includes a bottom piece that has three adjustments stems equally spaced around the perimeter of the base. Each of the adjustments stems are attached to the bottom piece and to a top piece in such a manner as to allow the top piece to be leveled when the adjustments stems are turned. Like the stand 22, The top piece of the tripod mounting base also can include a bubble level.

To use the laser level 10 with a tripod, for example to provide a true level on walls in a room: (1) set up the tripod anywhere in the room by extending and spreading the legs; (2) attach the tripod mounting base to the top of the tripod; (3) level the tripod mounting base by turning the three adjustments on the stand that are parallel with the ground clockwise or counter clockwise until the bubble level indicates that the mounting base is positioned at true level; (4) attach the laser level to the tripod mounting base; (5) turn the lasers on with the switch 24; and (6) adjust the lasers so that the beams project horizontally onto the walls and meet at the corners.

Most parts of the laser level 10 including the housing 12, the pods 14, and the stand 22, can be made of any suitable material such as, for example, molded plastic.

The user can project laser lines on any surface, for example, walls, floors, and ceilings. The laser lines are not affected by uneven surface features and can be projected on all surfaces in the path of the laser projection. The liquid bubble level 20 ensures that the laser level (and the corresponding guidelines 200) are based on true level.

While this invention has been described with respect to certain embodiments, the attached claims should not be read as being so limited, since to one skilled in the art, numerous variations and modifications of the components and methods will be readily apparent without departing from the spirit and scope of the invention.

1. A device for providing guidelines comprising:
a housing;
at least two pods attached to the housing and moveable with respect to the housing, each pod having a light source for projecting a guideline of light through a respective point on a respective surface;
a first adjustor for each pod to locate the respective point on the respective surface; and
a second adjustor for each pod to rotate the respective guideline through the respective point.

2. The device of claim 1 wherein at least two of the pods project the respective points at a right angle with respect to each other.

3. The device of claim 1 wherein the first adjustor comprises:
an attitude control for moving the pod with respect to the housing.

4. The device of claim 1 wherein the second adjustor comprises:
a lens for converting a beam of light from the light source into a guideline;
a frame for supporting the lens; and
a rotation control for rotating the frame.

5. The device of claim 1 further comprising:
a rotatable base having a first section which attaches to the housing, a second section for placement on a surface, and a rotation mechanism to allow the first section to rotate with respect to the second section.

6. The device of claim 5 wherein the rotatable base further comprising one or more pin units, each pin unit comprising:
one or more pins for connection to the surface on which the base is placed; and
an actuator for moving the pins from a retracted position inside the second section to an extended position such that the pins can penetrate the surface.

7. The device of claim 5 further comprising a suction cup unit comprising:
one or more suction cups for connection to the surface; and
a suction cup connector for connecting the suction cup to the base.

8. The device of claim 5 wherein the first section further comprises:
an attachment device for releasable attaching the housing to the first section.

9. The device of claim 8 wherein the attachment device comprises one or more magnets.

10. The device of claim 5 further comprising:
stops at certain angles of the rotation of the first section with respect to the second section.

11. The device of claim 5 further comprising a measuring device.

12. The device of claim 5 wherein the first section further comprises a level which indicates the true level of the base.

13. The device of claim 1 wherein the housing further comprises a level which indicates the true level of the housing.

14. The device of claim 1 wherein the housing further comprises:
a switch to activate any combination of the light sources; and
a source of power.

15. The device of claim 13 wherein the source of power are batteries provided inside the device.

16. A method of using a device for providing level lines which has a housing, at least two pods attached to the housing and moveable with respect to the housing, each pod having a light source for projecting a guideline of light through a respective point on a respective surface, a first adjustor for each pod to locate the respective point on the respective surface; and a second adjustor for each pod to rotate the respective guideline through the respective point, comprising the steps of:
placing the housing on a first surface;
adjusting each pod with each respective first adjustor to locate a respective point on a respective target surface; and
adjusting each pod with each respective second adjustor to rotate the respective guideline to a desired position.

17. The method of claim 16 further comprising the steps of:
attaching the housing to a base, the base having a first section rotatably connected to a second section; and
rotating the first section with respect to the second section to position the pods.

18. The method of claim 17 wherein the step of placing the housing on the first surface comprises the steps of:
engaging an activator in the base to move pins from a retracted position inside the second section to an extended position so that the pins can penetrate the first surface.

19. The method of claim 17 wherein the step of placing the housing on the first surface comprises the step of:
attaching a convex side of a suction cup to the base and the concave side of the suction cup to the first surface.

20. The method of claim 16 wherein the step of placing the housing on the first surface comprises the steps of:
attaching a tripod base to a tripod;
adjusting the tripod base to be at true level; and
attaching the laser level to the tripod base.
